(19) United States
(12) Patent Application Publication
(10) Pub. No.: US 2007/0053208 A1
(43) Pub. Date: Mar. 8, 2007

(54) Uv light source coated with nano-particles of phosphor

(75) Inventors: Thomas Justel, Witten (DE); Augustinus Gregorius Henricus Meijers, Breda (NL); Dietrich Bertram, Aachen (DE); Hans-Helmut Bechtel, Roetgen (DE); Herbert Friedrich Boerner, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/555,751

(22) PCT Filed: May 3, 2004
(86) PCT No.: PCT/IB04/50564

§ 371 Date: Nov. 4, 2005

(30) Foreign Application Priority Data
May 9, 2003 (EP) 03101289.1

(51) Int. Cl. F21V 7/04

(52) U.S. Cl. 362/629

(57) ABSTRACT

A luminescent body is described that comprises a optical waveguide plate, a UV light source, and means for coupling the UV light into the optical waveguide plate and in which the optical waveguide plate is provided with a covering layer that contains one or more phosphors that are either applied directly or may be embedded in spherical particles of synthetic resin material. These phosphors convert UV light of a wavelength from 300 to 400 nm into visible light of a wavelength from 420 to 480 nm. The covering layer has a thickness from 10 to 5000 nm and exhibits a light reflection of <20%.

The present invention relates to luminescent bodies that are produced by coupling light out of an optical waveguide plate using a layer of inorganic and/or organic phosphors in the form of nano-particles.

The emission of light by the coupling-out of light by scattering is a widely used technique. Light-scattering particles in the micrometer range have long been used for the effective distribution of light and give the light-guide sheet an opaque appearance. What this produces is a light source that is translucent, but not transparent.

It would be advantageous in many applications to have a light source that was transparent. This can be achieved by coupling the light out of the optical waveguide plate with nano-particles. For this purpose, light is coupled in at the edges of an optical waveguide plate, is distributed within the sheet by total internal reflection, and is then coupled out of the optical waveguide plate by scattering at a layer of particles having suitable properties that is coated onto the optical waveguide. If the size of the particles, the refractive index and the thickness of the layer are correctly selected, optical transparency can be achieved.

The advantages of the present invention lie in the new opportunities that are provided for the design of flat light sources, including their transparency, the color of the emission from the light source, and its natural color.

For flat light sources, and particularly for transparent sheets that can be used as optical waveguide plates and are covered with a light-scattering layer, there are innumerable possible applications. For example, many light-sources for backlighting LCDs are produced in this way. In all such applications, the scattering layers are optimized to provide the maximum possible coupling-out and uniformity for the light source.

The diameter of particles for scattering light is defined by the Mie theory. The scattering is usually laid down by the scattering parameter S, which is proportional to the diameter and packing density of the particles in the covering layer. The scattering parameter is a function of the particle diameter at a constant wavelength and it increases as the particle size decreases, reaches a maximum and finally goes back to zero when the particle size approaches zero. Conventional light sources use particle coatings having a high scattering power, in which case either particles of diameters close to the Mie maximum or thick layers are used.

The outcome is that up to 70% of the light is coupled out and the light source looks opaque. If the size of the particles is less than the optimum for scattering light, the layer becomes more and more transparent. At the same time, this reduces the coupling out of the light. If, however, the absorption of light within the optical waveguide is small, then the coupling-out is still high enough because of the wide variety of possible ways in which a photon can be coupled out.

The invention relates to a luminescent body comprising an optical waveguide plate 1, a UV light source 2 and means for coupling the UV light into the optical waveguide plate, which sheet is provided with a covering layer 3 that contains one or more phosphors that are either applied directly or may be embedded in spherical particles of synthetic resin material and that convert UV light of a wavelength from 300 to 400 nm into visible light of a wavelength from 420 to 480 nr, the particles of synthetic resin material having a diameter of between 10 and 500 nm and exhibiting a light reflection of <20%.

These phosphors in the covering layer on the one hand cause the light to be coupled out of the optical waveguide and on the other hand convert the UV light into visible light of a longer wavelength. One or more inorganic or organic phosphors may be embedded in spherical particles of synthetic resin material.

The phosphor properties of the light-scattering particles can also be used to produce flat, transparent light sources that emit white light.

The covering layer applied to the optical waveguide plate is generally from 20 to 5,000 nm thick. A fluorescent tube is used as a primary light source to couple the light into the optical waveguide plate. What may also be used as a primary light source, however, is an arrangement pf AlₓGa_{y}In_{z}N LEDs in which x, y and z may assume values between 0 and 1 and the sum of x+y+z is 1.

To produce a luminescent body according to the invention that emits white light, an organic phosphor shown in Table 1 that is dissolved in a polymer precursor may be used. To produce white light, two or more suitable phosphors from Table 1 are mixed together and dissolved in the polymer precursor. The polymer precursor is polymerized in this case by a method in which spherical nano-beads of a size between 5 and 500 nm are obtained, as described, for example, in German applications laid open to public inspection 198 41 842 and 199 08 013 by BASF. The preferred polymer precursor in this case is polymethyl methacrylate, because it is transparent down to a particle size of 300 nm. Other suitable polymers are polyethylene, polyvinyl chloride, polytetrafluoroethylene, polystyrene or polycarbonate. The nano-beads obtained in this way are then applied to the optical waveguide to give a layer thickness of from 20 to 5,000 nm. Phosphors suitable for the luminescent bodies according to the invention are shown in Table 1.

TABLE 1

| | Color of | Wavelength |
|---|---|---|
| Phosphor | emission | of emission (nm) |
| Lumogen F violet 570 | Blue | 425 |
| Coumarin 120 | Blue | 440 |
| Coumarin 152 | Green | 520 |
| Lumogen F yellow 083 | Green | 490, 520 |
| Lumogen F yellow ED206 | Yellow | 555 |
| Lumogen F orange 240 | Orange | 545, 575 |
| Lumogen F red 300 | Red | 615 |

The use of inorganic phosphors of a particle size in the nano-range is also highly suitable for the production of the luminescent bodies according to the invention. Their particle size should be in the range between 1 and 300 nm in this case. Nano-particles are then applied to the optical waveguide in the form of a covering layer, in which case the thickness of the layer should preferably be between 20 and 5,000 nm. Suitable inorganic phosphor pigments are oxides, sulfides or nitrides and semiconductive materials having a crystal lattice, pigments having a high refractive index such as MgWO₄, CaWO₄, Y₂O₃ (n≈1.9), CaS, SrS (n≈2.1) or ZnS (n≈2.4) being particularly preferred. These pigments are activated either by Eu²⁺, Ce³⁺, Eu³⁺, Tb³⁺, Pr³⁺, Mn²⁺, Ag²⁺, Pb²⁺, Cu²⁺ or Bi³⁺, or have a direct optically permitted transition between the conducting and valence states. In the latter case, a reduction in the size of the particles leads to a change in the emission properties. In particular, as the particle size decreases there is a rise in the energy of the emission, i.e. a shift in the color of the emission from red thru yellow and green to blue. Inorganic phosphors of this kind are preferably produced by synthesis of the colloid chemistry type. Inorganic phosphors that are particularly preferred are listed in Table 2.

TABLE 2

| Phosphor pigment | Color | Emits at (nm) | Color point x | Color point y |
|---|---|---|---|---|
| Sr2P2O7:Eu | Violet | 420 | 0.17 | 0.01 |
| CaWO₄ | Bluish-white | 420 | 0.17 | 0.1 |
| CaWO₄:Pb | Bluish-white | 440 | 0.18 | 0.21 |
| (Ba1—xSrx)5(PO4)3(F,Cl):Eu | Blue | 450 | 0.15 | 0.07 |
| ZnS:Ag | Blue | 450 | 0.15 | 0.05 |
| BaMgAl10O17:Eu | Blue | 453 | 0.15 | 0.07 |
| BaMgAl10O17:Mn, Eu | Blue-green | 453, 515 | * | * |
| Sr4Al14O25:Eu | Blue-green | 490 | 0.14 | 0.35 |
| MgWO4 | Bluish-white | 480 | 0.24 | 0.34 |
| SrAl2O4:Eu | Green | 520 | 0.14 | 0.35 |
| ZnS:Cu | Green | 530 | 0.31 | 0.61 |
| SrGa2S4:Eu | Green | 535 | 0.27 | 0.69 |
| CePO4:Tb | Green | 545 | 0.34 | 0.58 |
| Y3Al5O12:Ce | Yellow | 560 | 0.45 | 0.53 |
| (Y1-x-yGdxLuy)3(Al1—yGay)5O12:Ce | Yellow | 520-580** | ** | ** |
| ZnS:Mn | Orange | 590 | 0.58 | 0.42 |
| (Y1—xGdx)2O3:Bi, Eu | Red | 612 | 0.65 | 0.34 |
| Y(V1—xPx)O4:Eu | Red | 620 | 0.66 | 0.33 |
| Y2O3:Eu | Red | 620 | 0.66 | 0.33 |

The color points that are marked * depend on the ratio of the concentrations of activator/co-activator.
Emission wavelengths and color points that are marked ** depend on the corresponding cation ratio.

An overview of the preferred phosphors having direct gaps in their bands, i.e. what are called quantum dots, can be found in Table 3. These are self-luminescing particles that have an intrinsic viscosity.

TABLE 3

| | |
|---|---|
| Groups II-VI of the periodic table | CdSe, CdTe, ZnS, ZnTe, ZnSe, CdS, HgS, |
| | HgSe, HgTe, CdSeS, CdTeSe, CdTeS, |
| | ZnSSe, ZnTeSe, ZnSTe, CdZnSe, CdZnTe, |
| | CdZnS |
| Groups III-V of the periodic table | GaAs, GaP, GaSb, GaN, InN, InP, InAs, |
| | InSb, InGaP, InGaAs, InGaN, AlInGaN, |
| | AlInGaP, AlInGaAs |
| Group IV of the periodic table | Si, Ge |
| Core-shell (core of one material, shell of a | (CdSe)ZnS, (CdTe)ZnS, (CdSe)CdS, |
| different material) | (CdTe)CdS, (InP)ZnS, (InN)GaN |

A light source emitting white light can be obtained by using a mixture of phosphors that contains either a blue and a yellow-orange phosphor or a blue, a green and a red phosphor. The most preferable examples of this are:

1. Sr₄Al₁₄O₂₅:Eu and ZnS:Mn

2. BaMgAl₁₀O₁₇:Mn,Eu and ZnS:Mn

3. ZnS:Ag, ZnS:Cu and YVO₄:Eu

4. BaMgAl₁₀O₁₇:Eu and Y₃Al₅O₁₂:Ce

5. BaMgAl₁₀O₁₇:Eu and (Y_{1-x-y}GdₓLu_{y})₃(Al_{1-y}Ga_{y})₅O₁₂:Ce

6. BaMgAl₁₀O₁₇:Eu, CePO₄:Tb and Y(V_{1-x,y}Pₓ)O₄:Eu

7. BaMgAl₁₀O₁₇:Eu, CePO₄:Tb and Y₂O₂S:Eu

8. (Ba₁₋ₓSrₓ)₅(PO₄)₃(F,Cl):Eu and Y₃Al₅O₁₂:Ce

9. (Ba₁₋ₓSrₓ)₅(PO₄)₃(F,Cl):Eu and (Y_{1-x-y}GdₓLu_{y})₃(Al_{1-y}Ga_{y})₅O₁₂:Ce.

The primary light coupled into the optical waveguide generally has a wavelength of between 300 and 400 nm. It may be generated either by an arrangement of AlₓGa_{y}In_{z}N LEDs or by a fluorescent lamp that contains a UV phosphor. The preferred phosphors in this case are LaPO₄:Ce (320 nm), (Y,Gd)PO₄:Ce (345 nm), BaSi₂O₅:Pb (350 nm) or SrB₄O₇:Eu (370 nm).

The luminescent bodies claimed have a series of important advantages:

the color of the fight emitted is determined by the coating of the optical waveguide and can easily be modified by changing the phosphor or the mixture of phosphors;

a flat light source of high transparency can easily be obtained because UV light is more strongly scattered by quite small particles than white light;

a flat light sheet may be either colorless or, if the layer that couples out the light contains phosphors having an absorption in the visible range, may be colored with the corresponding color of the phosphor.

They may be used in a wide variety of ways. One possibility is for them to be used to illuminate an automobile roof lining and another is for them to be used to illuminate a window.

These and other aspects of the invention are apparent from and will be elucidated with reference to the example described hereinafter.

In the drawings:

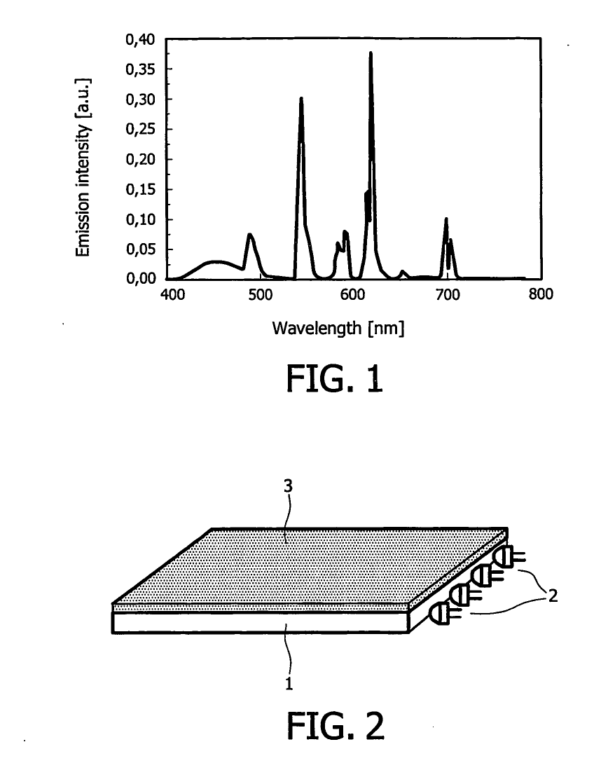

FIG. 1 shows the emission spectrum of a flat transparent light source into which light is beamed from an arrangement of Al_{0.57}Ga_{0.5}In_{0.05}N LEDs and from which light is coupled out by a layer that contains a mixture of BaMgAl₁₀O₁₇:Eu, CePO₄:Tb and YVO₄:Eu.

FIG. 2 shows the schematic construction of a transparent light source having LEDs as its primary light source.

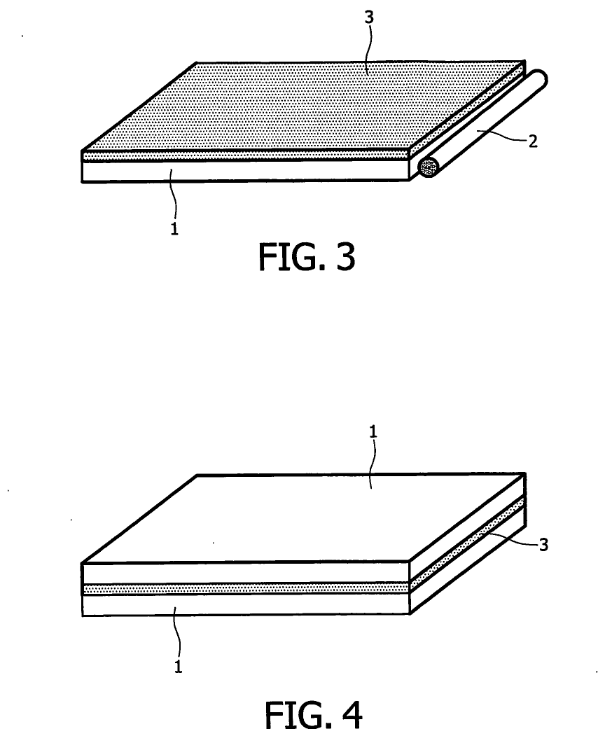

FIG. 3 shows the construction of a transparent light source having a fluorescent lamp as its primary light source.

FIG. 4 shows the schematic construction of a transparent light source in which a layer that couples light out is placed between two light guides.

### EXAMPLE

Sheets of polymethyl methacrylate are coated on one side with a suspension comprising a mixtures of nano-particles of BaMgAl₁₀O₁₇:Eu, CePO₄:Tb and YVO₄:Eu. The concentrations of these three phosphors are so adjusted that a white spectrum is obtained when they are excited by UV light.

The sheets of polymethyl methacrylate are stacked in such a way that a sandwich is created, in the manner shown in FIG. 4. An arrangement of Al_{0.57}Ga_{0.5}In_{0.05}N LEDs, which are arranged at the edges of the optical waveguide, is used as the primary light source. The spectrum of the light emitted is shown in FIG. 1. The color rendition of this light source is approximately 90 at a color temperature of 4,000 K.

1. A luminescent body comprising an optical waveguide plate (1), a UV light source (2), and means for coupling the UV light into the optical waveguide plate, characterized in that the optical waveguide plate is provided with a covering layer 3 that contains one or more phosphors that are either applied directly or may be embedded in spherical particles of synthetic resin material and that convert UV light of a wavelength from 300 to 400 nm into visible light of a wavelength from 420 to 480 nm, the particles of synthetic resin material having a diameter of between 10 and 500 nm and exhibiting a light reflection of <20%.

2. A luminescent body as claimed in claim 1, characterized in that the covering layer contains one or more inorganic phosphors that may be embedded in spherical particles of synthetic resin material.

3. A luminescent body as claimed in claim 1, characterized in that the covering layer contains one or more organic phosphors that may be embedded in spherical particles of synthetic resin material.

4. A luminescent body as claimed in claim 1, characterized in that the phosphors, which may be embedded in the spherical particles of synthetic resin material, convert the UV light that is put into colored or white light.

5. A luminescent body as claimed claim 1, characterized in that the covering layer applied to the optical waveguide plate produces a layer thickness of 20 to 5000 nm.

6. A luminescent body as claimed in claim 1, characterized in that a fluorescent tube is used as a primary light source.

7. A luminescent body as claimed in claim 1, characterized in that an arrangement of AlₓGa_{y}In_{z}N LEDs in which x, y and z may assume values between 0 and 1 and the sum of x+y+z is 1 is used as a primary light source.

8. A luminescent body as claimed in claim 1, characterized in that the covering layer containing the spherical particles of synthetic resin material is applied to a film that is placed between two or more optical waveguide plates.

9. Use of a luminescent body as claimed in claim 1, characterized in that it is used to illuminate an automobile roof lining.

10. Use of the luminescent body claimed in claim 1, characterized in that it is used to illuminate a window.
